(19) United States
(12) Patent Application Publication
(10) Pub. No.: US 2008/0228870 A1
(43) Pub. Date: Sep. 18, 2008

(54) Method For Transmitting Information From an Information Server to a Client

(75) Inventor: Rene Schweier, Stuttgart (DE)

Correspondence Address: CENTRAL COAST PATENT AGENCY, INC, 3 HANGAR WAY SUITE D, WATSONVILLE, CA, 95076, US

(73) Assignee: HURRA COMMUNICATIONS GMBH, Stuttgart (DE)

(21) Appl. No.: 12/063,899

(22) PCT Filed: Jun. 29, 2006
(86) PCT No.: PCT/EP2006/006296

§ 371 Date: Feb. 15, 2008

(30) Foreign Application Priority Data
Aug. 18, 2005 (EP) 05017921.7
Nov. 26, 2005 (EP) 05025837.5

(51) Int. Cl. G06F 15/16

(52) U.S. Cl. 709/203

(57) ABSTRACT

During the transmission of information from a first information server (3) to a client (9) with which a profile (15) is associated, by means of a communication network (2) in a client-server system (1a), the load on the resources of the client server system (1a) and the communication network (2) is reduced as much as possible. To this end, the relevance of the information is increased. At least one second information server (6) is connected to the communication network (2), the profile (15) is generated by a profile server (13) connected to the communication network (2), and at least one profile information message is evaluated in order to generate said profile (15). The profile information is determined according to at least one property of a network page (8) transmitted to the client (9) by the second information server (6).

This invention relates to a process for the transmission of information from a first information server to a Client, wherein
the first information server and the client are connected to a communication network;
a profile is assigned to the Client
at least one additional information server is connected to the communication network;
through the additional information server at least one additional bit of information is provided;
by means of the Client a network page is requested via the communication network from the first information server;
depending on the profile assigned to the Client, additional information is selected; and
the requested first network page and the additional information are transmitted to the Client.

The present invention also describes a Client-Server-System comprising a client that is assigned to a user, a first information server, an additional information server, and a communication network, enabling a communication between the client and the first information server is possible, wherein
the Client-Server-System comprises means for the assignment of a profile to a client,
the additional information server is connected to the communication network;
the additional information server makes at least one additional bit of information available;
the Client comprises means for requesting the first information server a first network page via the communication network;
the Client-Server-System comprises means for selecting additional information depending on the profile assigned to the Client; and
the Client-Server-System comprises means for transmitting the requested first network page with the additional information from a first server to the Client.

The present invention also relates to a profile server in a Client-Server-System, wherein
the Client-Server-System comprises a user assigned Client, a first information server, an additional information server, and a communication network;
the profile server comprises means for the assignment of a profile to the Client;
the additional information server is connected to the communication network;
the additional information server provides at least one bit of additional information;
the client comprises means for requesting the first information server a first network page via the communication network;
the Client-Server-System comprises means to select additional information depending on the profile that is assigned to the client;
and the Client-Server-System comprises means for transmitting the requested first network page with the additional information from the first server to the client.

The invention also finally relates to a computer program which is able to be run on a Client-Server-System, in particular on a client and/or a server.

A multitude of clients and servers communicate via the internet. These comprise in their totality a multimedia information system, the so-called WWW (World Wide Web). Network pages that are provided within the WWW can be addressed by means of a URL (Uniform Resource Locator). A URL is configured among other things from the name of the server that makes the network page available, a (at least virtual) directory and a name that is assigned a network page, for example a so-called HTML document. A URL permits the network page that is assigned to this URL to be called by the client. In addition a user inputs for example by means of a keyboard the URL into a special input field of a computer program, a so-called browser, which runs on the client. The client thereupon generates a request to the corresponding server which again transmits the requested network page to the client. There the transmitted network page is interpreted by means of a browser and reproduced to the user via a display that is assigned to the client.

A page description language is used to describe the content of a network page. Today, overwhelmingly a standardized page description language HTML (Hypertext Mark-up Language) is employed. HTML allows by simple means the description of the content and the appearance of a network page in a so-called HTML document. Should a client for example request information from a server, then the server transmits to the client an HTML document which contains the requested information. Should the information transmitted to the client by means of the HTML document be reproduced to a user, then the network page or the HTML document is directed to the browser.

Instead of being assigned to a network page, a URL can also be assigned to an executable computer program on the server. Such a computer program can be a so-called Perl script. A Perl script is a series of command codes in the Perl program language. Should the client request a URL that is assigned to this type of a computer program, then this computer program is executed on the server. The execution of the computer program can also include a transmission of information to a client, for example in the form of a network page. In particular the automatic creation of a network page can thus be caused by means of the computer program. The automatic creation can comprise the selection of the content and the selection of parameters related to the layout. Naturally, the computer program can be realized in another language, in particular in another script language such as java script.

It is possible in an HTML document to present URLs of additional network pages or other HTML documents. Such URLs are called pointers or links. A link is a pointer that can be activated. Where links are reproduced to the user by means of a browser, then the user has the possibility of selecting or activating a reproduced link and to be pointed to the network page corresponding to the selected URL. It is thereby especially possible that the selected network page is located on a different server.

An information server can be for example any so-called web server. A web server is a server which holds WWW information ready for a call. An information server is also for example a server which contains up-to-date messages. Such servers are used for example by providers of large daily newspapers or weekly magazines.

Thus each component in a communication network, or in each component that is connected to a communication network, is a server if it holds data ready for request. The server is designated as an information server, particularly when such data are intended for reproduction to a user. Being held ready for a request does not compel that the information should be targeted in a request. In particular it is common in the WWW sector for information to be transmitted from a server to a client even though the client has not specifically requested this information. Such information includes for example advertising which is transmitted by an information server to the client.

The mail server must be considered an information server even upon an unrequested transmission of information to a client, such as is the case for example when so-called spam or undesired e-mail is transmitted.

A so-called online shop is also an information server because from the online shop information can be requested such as for example information relating to products offered for sale by the online shop. This shows that the functional scope of an information server is not limited purely to the transmission of information. Rather here the point of view of the client server principle, which is known in information technology, acts as the basis for designating each component that provides a service, a server; and each component, that requests a service, a client. As a result each component can consequently function both as a client and as a server. Thus naturally a hardware component, that is for example a computer, can realize simultaneously the functionalities of several clients and several servers or almost simultaneously realize them in that these functionalities are partially realized also in software.

In particular, an information server is also realized in the form of a so-called search engine. A search engine is a server that is connected to a communication network and in particular to information servers to which the user sends a request by means of the client in the form of a search term. The search engine determines information on the basis of predescribed rules depending on the transmitted search term, which information is associated with the search term. The search engine causes the determined information (the search result) to be transmitted to the client by means of a network page. In addition and often depending on the received information, a dynamic HTML document is automatically created by the server, which is finally transmitted to the client and is pointed out to the user by means of a browser.

Often additional information is reproduced on the network pages that are created by a search engine depending on a request for information for example in the form of so-called advertising banners. The additional information can be provided via the communication network by the information server itself or by an additional information server of a special servant. It is known that the additional information selected depends on the input search term.

The additional information can be any type of information that is transmitted to the client, although it is not explicitly requested by an information server. Here the information server can naturally show simultaneously the additional information server's functionality. A separation of these terms serves—as is common in the information processing field—primarily for the representation of the different functionalities and not for the designation of a concrete component that realizes this functionality.

Additional information can be provided with a link. An activation of the link by the client or by a user, which is assigned to the client, can then cause the request of another network page which is provided by the first information server.

The additional information can also be provided with a link in such a manner that the activation of the link causes the execution of a computer program stored on the first information server, such as for example a script. Such a script can for example be realized as Perl script.

The transmission of additional information together with the network page of the first information server to the client can also cause the transmission of a script such as for example a so-called java script. An activation of the link results in an execution of the script on the client.

Depending on the execution of the script, additional action can be performed. For example, statistical data relating to the calling of a specific network page can be compiled on the information server or additional network pages can be requested by the client or transmitted to it.

If the information server transmits a network page to the client, then the information server can additionally transmit a so-called cookie to the client. A cookie is a sum of information that is stored on a storage area assigned to a client. One speaks here of “setting the cookies”. It may be provided that a cookie is automatically set when the client activates a link that is reproduced on a network page. Should the client request a network page anew from the information server, then it can additionally be provided that the cookie is transmitted together with the client request to the information server. A cookie is usually realized such that it can only be resent to the information server which caused the client to set the cookies.

In particular profile data can also be stored in a cookie, that is for example how often a user to which the client is assigned calls a particular network page or when the last time was when he called the network page.

The classification of network pages that are prepared by the information server is known. This can take place for example on the basis of the thematic content of the network page. Profiles can then be established in passing so that a statement can be made on which themes the user is particularly interested.

Usually a profile can designate an individual user profile that is exclusively assigned to a particular user as well as a characteristic or several characteristics which enable the classification of the user according to specific, reproducible characteristics. In particular, the profile itself can even designate a class that is assigned to the user. The profile that is assigned to the client can thus specifically designate the user assigned profile when the user is registered with the client, for example a personal computer, a PDA, or a mobile telecommunication device, and the client is connected to the communication network. Thus, the user assigned profile can also be viewed as assigned to the client or the other way around, provided something else does not result from the context.

If the information server is designed as a search engine, then the user profile can result depending on the search terms input by it. In evaluating the profile, the information server can cause the transmission to the user or the user assigned client of only that type of additional information that fits the profile. Thus, for example, additional information can be appropriately classified.

By means of such a selection of additional information, it is possible to elevate the relevance of the additional information transmitted to the user. Thus, on the one hand, a reduction of the sum of the data to be transmitted via the communication network can be achieved. On the other hand a reduction in the calculation requirements of the information server can be achieved.

The information server may concern as an example a product search engine on which a user typically searches one or more products depending on differing criteria. The differing criteria such as price range, manufacturer, product type, etc. can be input by means of the search terms. The product search engine evaluates the search terms and transmits these to a results list on the user assigned client.

In addition, the product search engine can transmit additional information. The additional information can for example describe similar products, reproduce thematically related advertising specials, reproduce comparisons between similar products, or offer accessories. If the user profile shows that the user searched for health products at some earlier time, then it can be concluded that the user pays attention to his health. Together with the products that are now being searched additional information can then be transmitted from the server to the client which contains tests of the represented products relating to health aspects or which point to other network pages which contain such information types.

Where the user is thus offered relevant additional information, then he does not need to search for this information himself, which search would normally consist of several transfers of information between the client and one or more information servers thus resulting in an avoidable burden on the communication network and the information server.

The known process has the advantage however, that the profiles established by the information server are inexact because creating the profiles only limited information can be evaluated and these often no longer reflect an up-to-date situation. The interests of a user can for example very quickly change or a searched for product may not have been purchased in the meantime, so that the profiles that are based on these searches may no longer be up-to-date.

The WWW is a worldwide communication network based on the so-called internet, to which millions of servers and clients are connected. The number of servers and clients and in particular also the sum of the data transferred between the servers and the clients has significantly risen since the creation of such communication networks and it will continue to strongly rise, as increasingly more information is transmitted via communication networks.

In order to do justice to the continuously growing user need for information or of clients which are assigned to these users, various techniques are employed. On the one hand communication networks with higher band widths are located or employed, or existing communication networks are expanded. An example of this from the network telecommunication sector is the development of the so-called UMTS (Universal Mobile Telecommunications System) which is currently replacing the less performance capable GSM (Global System for Mobile Telecommunications).

On the other hand compression algorithms are being developed and employed which are reducing the sum of data that is being transferred on the communication networks.

An additional possibility for mastering the increased need for information, are techniques that increase the speed of requests for information through an optimization of the request process. By means of such optimization techniques, one is specifically attempting to increase the speed of conventional processes for requesting information so that the request itself and/or the transmission of information is made possible through the transmission of a least possible number of data or data packages. This can lead to a reduction of the so-called network traffic, that is of the data that is to be transmitted per time unit via a communication network.

With a clearly increasing tendency, products are for example offered by information servers or by online shops, that is goods, services, and information, and are purchased by users or customers at the online shops. The data to be transmitted for a purchase of a product at an online shop between the user or between a user assigned client and the online shop or several servers that are assigned to the online shop, create a significant portion of the network traffic within a communication network. To this end in particular, the search and request for information must also be calculated which leads finally to the ordering or the purchase of a product.

With equally increasing tendency, general information is today requested from information servers. The constantly increasing number of accesses to search engines shows that the user often searches for very special information or very special information servers. In order to reduce the sum of the data that is to be transferred via the communication network, there exist so-called meta search engines that direct targeted inquiries to a search engine when there is present on their part an inquiry from a client by means of a search term, evaluate the results in order to increase the likelihood of direct hits and thus reduce the number of searches with no results. As a result a reduction is achieved in the waste of communication network resources through unnecessary data transfer.

It is therefore the assignment of the present invention to create a process which permits the increase of the relevance of additional information that is transmitted to a client, thus leading to a protection of resources as well as of the communication network through a reduction of the information that is to be transmitted via the communication network on the one hand, and a reduction of the burden on information servers on the other hand.

Specifically by increasing the relevance of additional information that is to be transmitted to a client, a reduction of the so-called online time is to be achieved, whereby the online time describes the time that the user requires to exchange information by means of a client that is assigned to him to exchange information with one or more information servers.

The assignment is solved in the present invention by connecting at least a second information server to the communication network, establishing the profile through a profile server that is connected to the communication network, and evaluating at least one profile data for creating the profile, whereby the profile data is determined depending on at least one characteristic of a network page that is transmitted to the client from the second information server.

According to the present invention, the profile is created by a profile server that is connected to the communication network. In the process not only so-called information profiles of the first information server are used, but information profiles of the second information server are also used. Thereby it becomes possible to create profiles with greater accuracy. Thus again a selection of the additional information to be transmitted to the client from the first information server can occur with higher precision, which leads to a higher relevance of the additional information.

The process according to the present invention has thus not only the advantage that a particularly great deal of information is provided for creating or updating of a profile, but that also that a profile has a very high current relevance because the frequency is thus increased of capturing profile data which is created by the profile not on the bases of profile data from the first information server but in particular on the basis of profile data from the second information server.

This makes it possible to reproduce additional information to the user by means of the requested network page in an especially quick and flexible manner and in consideration of a current user situation.

In addition, the process according to the present invention makes it possible that the additional information not only be reproduced on network pages that are transmitted from the information server over which the profile data are determined, here for example via the second information server, but also on network pages which are transmitted by other information servers to the client, here for example the first information server. Thus there is again an especially quick and prompt assurance of relevant information supply to the user or to the client. The user has accordingly no cause to burden the communication network on the one hand as well as the information server on the other hand with searches for additional information.

By means of the process according to the present invention, online time can thus be reduced. Thus a significant reduction in energy consumption can be achieved, as on the one hand data transfer is naturally only required by means of electrical energy and on the other hand the user uses the client, or a PC, for a shorter time period.

It is preferred that the first and/or the second information server be designed as a search engine, a product search engine, an online shop, an online forum, or a news server.

These types of information servers have the advantage of being able to gather particularly relevant profile data for creating profiles and transmitting them to the profile server. For example, the profile server can determine user preferences from profile data that describe goods that are purchased or not purchased via an online shop. Via an online forum, information can be determined about themes that interest the user. A news server has current information on varying themes available. A user can for example subscribe to varying themes. On the basis of subscribed themes, it is possible to obtain additional information toward creating the user profile. The information server can be designed specifically as any type of web server.

Advantageously, a condition is assigned to the profile data and the profile data is taken into consideration for creating of a profile only when the profile data meets the condition.

Through the assignment of a condition, the quality of a profile and thus the relevance of the additional information that is obtained on the basis of the profile can be additionally elevated.

For example, the condition is described through a point in time, a period of time, an identification of an information server, or a type of information server.

Through such use, a particularly high current relevance for the profile can be achieved, because outdated profile data is no longer drawn upon for profile relevance. In the following the creation of a profile includes bringing it up-to-date. For example, it can be conceived that a product search which was completed more than twenty days earlier no longer be taken into consideration when creating a profile. Or it can be conceived not to use the profile data of an information server that is to be identified through a identification upon the creation of a profile. If a type is assigned to the information server, then for example it can be provided not to use the profile data of a news server, in which case the profile data of a search engine should be used to create the profile.

In particular several conditions can be assigned to profile data. It can thus for example be established to only take into consideration profile data from a product search engine within ten days of the transmission of the profile data upon the creation of a profile, while on the other hand the profile data which is determined from an online forum is used within thirty days after its ascertainment. Thus consequently an especially high flexibility and an especially high currency profile can be achieved.

In a preferred continued development of the process the network page that is called by the client at the first information server has at least one characteristic assigned to it. The additional information is selected depending upon an evaluation of this characteristic. Preferably it describes at least one characteristic of the network page that is requested by the client at the second information server or of the network page that is transmitted from the second information server to the client, namely a content, a source, a period of time, an executed action, or a non-executed action.

The content of a network page can for example be described by means of a prior classification of the network page that was provided by the first or by the second information server. By evaluating the content or by its classification, an even higher relevance of the additional information can be achieved. Should the first information server be designed for example as an online shop, the varying product categories can be reproduced on varying network pages as requested by the online shop. If the user now has requested a network page on which accessories to varying products are offered, then by means of the process according to the present invention it can be achieved that additional information is transmitted to the user, which describes an accessory to the product that was already purchased earlier. In this case, he information on the purchased product can be obtained from the profile. The information about the fact that the user could be interested in an accessory to this product can also be derived from the characteristic of the requested network page if this for example describes the content and is classified as an “accessory”.

The source of a transmitted network page can describe a preceding action which triggered the transmission of the network page to the client. In particular, which network page was called by the client on a prior occasion can be determined by means of the source. If the network page was requested on the basis of a link that is reproduced on another network page, then for example the URL of the preceding network page can be determined by means of a so-called referrer. This specifically makes it possible to determine the information server which transmitted the preceding network page to the client.

The period of time describes for example the time between the request for a network page and the request for an additional network page that is provided by the information server or an additional information server. It can subsequently be determined from the time period whether the user has looked more closely at the information that is reproduced on the network page, this being thus of possibly primary interest, or whether the user has requested within a very short period of time an additional network page which network page was consequently of rather limited relevance to the user.

An executed action can for example be the activation of a link that is reproduced on a network page that has been transmitted to the client. Correspondingly a non-executed action can be the non activation of a link that is reproduced on the network page. Additionally, within an action a collection of several sub actions can be understood. Should the first or the second information server be for example designed as an online shop, then the executed or non-executed action can describe the executed or the non-executed purchase.

These characteristics are especially suitable for the generation of profile data that can be assimilated into a profile.

The profile can for example be created by means of an expert system depending on the characteristics of the network page that is requested from the second information server. An expert system describes the arrangement and extraction of knowledge within the frame of the so-called artificial intelligence. An expert system is for example designed as a so-called rule-based expert system. In this case, the processing of prescribed rules generates a decision or in the present case determines a profile. This makes it possible in establishing the profile to take into consideration all characteristics that are available and to establish the profile in a type of decision tree depending on the characteristics and as they case may be on the conditions that are assigned to the profile data.

The to be reproduced information can also be selected advantageously by means of an expert system depending upon the created profile. Where the expert system is designed as a rule-based expert system, the additional information can be selected through processing of prescribed rules. This can take place for example in a type of decision tree depending on the profile's individual parameters.

In an additional advantageous development of the process, where the first information server requests the transmission of the profile from the profile server, the profile server transmits the profile to the information server and the information server selects on the basis of the profile an appropriate additional information. In this case the information server can for example show also the functionality of the additional information server. In addition the information can be assigned to a database, in which the additional information is stored. In particular the additional information server can thus be designed as software.

This has the advantage that the information server can create and implement particularly flexibly and independently of the profile server, rules for the selection of additional information.

According to another advantageous development of the present invention, the first information server requests from the profile server the additional information, in which case the profile server selects the additional information depending on the profile.

The selection of a suitable additional information is processed consequently by the profile server according to the execution form. This has the advantage that the intelligence necessary for the selection need only be present on the profile server. In addition the communication network is less burdened because no transfer of a profile takes place from the profile server to an information server. For the selection it can be conceived that additional information itself, or information that makes possible the identification of additional information stored on an additional information server, is stored on a database that is assigned to the profile server.

According to an additional preferred embodiment of the present invention, the profile is transmitted to the additional information server and the selection of the additional information is processed by the additional information server depending on the transmitted profile.

In this case, the profile server can be operated completely independent of the additional information that is provided. For the selection of a suitable additional information the profile is transmitted to the additional information server, which takes on the selection of an appropriate additional information depending on the profile.

The transmission of the selected additional information causes the profile server for example to transmit an information identifying the selected additional information to the information server. This can take place on the one hand by the transmission of the additional information directly to the information server. On the other hand it is possible that the profile server transmits for example a URL to the information server under which the additional information is callable from an additional information server. This is especially advantageous where the additional information does not need to be directly reproduced on the network page but only needs to be reproduced as a link on the network page of the additional information server.

In particular such a combination can be conceived where the additional information that is to be reproduced on the network page contains a directly producible information as well as a link to secondary information or for example to graphic information which is to be reproduced on the network page.

In a preferred additional advantageous development of the process, for the assignment of the profile data to the profile, at least one identification that is assigned to the client is evaluated. In this case the identification that is assigned to the client is for example transmitted to the profile server together with the profile data. This makes it possible in a particularly simple manner to assign profile data to an already existing or a to be newly created profile.

Selected by evaluation, preferably at least one of the identifications assigned to the client is chosen for the selection of the profile to be used with the additional information. The at least one bit of user identification makes it possible to consequently find the user or client assigned profile to then carry out the selection of the additional information depending upon the evaluation of the profile. A identification can for example be a so-called user identification or user-id, enabling the user registers with an information server, which is for example an online shop.

In this case it can be conceived that the information server transmits the identification to the profile server, this latter evaluates the identification, selects the profile, and resends the selected profile to the information server, selects an additional bit of information or causes an arranged tracking system to select an additional bit of information.

By means of this embodiment of the process according to the present invention several identifications that are assigned to a user and/or a client can specifically be evaluated in order to select the profile that is assigned to the user. This can be advantageous for example where a identification that is assigned to the user or the client is not an unambiguous identification or where there is the possibility that this identification is also being used by another user or client.

It is especially advantageous in this case if the identification comprises a cookie, a device number, or an individual dial-in number. That the cookie is set from the profile server at the client can also be specifically provided for. A device number can for example be the number of a network card. This makes an unambiguous identification of the client possible. A dial-in number can be for example a user recognition that is assigned to the user with which the user registers by means of the client assigned to it, for example via an access provider, on the communication network. Additionally this makes it more possible that the user or the client can be assigned a profile, without a real identity as for example the user's name and address being known so that the user's anonymity can remain secure.

Preferably several identifications are assigned to the profile. It can be conceived that a cookie is set on the client at each action that is initiated by the client such as for example the request of a network page, the activation of a link, the purchase of a product, or the search for information. This has the advantage that the characteristics that describe an activation of a link can be stored in a cookie on the client and that this information can be requested by the profile server also again in the form of a cookie that is set on the client.

Thus it is possible for the profile server to extract the required information for creating or updating a profile independent of the first or second information server directly from the cookies that are stored on the client.

In particular, a dial-in number or device number can be drawn upon for the identification of the user, the client, or the profile independent of or in addition to the cookies.

According to an especially preferred embodiment of the process according to the present invention, a behavior of the user is evaluated and the identification is formed depending on the evaluation of the behavior.

A behavior of the user can for example be obtained in such a manner that a time period is determined during which the user requests with approximate regularity an information from a possibly specific information server.

The evaluation of the user's behavior can be employed particularly in connection with one or more other identifications for the selection of the profile. If for example a client comprising the form of a PC is used by multiple users, whereby one user uses this PC during the day and the other uses it on the other hand primarily at night, then through the evaluation of the actual time of the user and thus the profile that is assigned to him can be determined. A behavior can also be described through the input of specific symbols by means of a keyboard that is assigned to the client.

Also from specific settings of a computer program running on the client, for example a browser, the behavior of a user can be determined. Especially through the evaluation of so-called log files which are created through software running on the client, a behavior of the user can be established. A log file can for example be created by a browser and can contain information about the point in time and the identity of an information server from which the user has requested information. A log file can also contain information about when and how long the user was registered with the client, an information server, or the communication network.

Preferably the behavior is determined depending on at least one position of a pointer device that is assigned to a client. Such a pointer device is for example a so-called computer mouse, a touchpad, a trackball, or a keyboard that is assigned to the client. By means of a pointer device a user can move a position mark over the content reproduced on a screen, which mark is reproduced graphically for example as an arrow on the screen that is assigned to the client and can for example mark individual positions of the reproduced content. A reproduced link can be also activated especially by means of a pointer device. A position can thus for example be described by means of the so-called X-Y coordinates of the pointer device.

As an advantage the behavior is determined depending on a course of movement of a pointer device that is assigned to the client. A course of movement can for example be described through a series of the pointer device's positions. In particular such a series of positions can be provided with a time information. Thus it becomes possible to judge whether and how long the pointer device was positioned at a specific position or in a given environment of a specific position. From this on the one hand can be derived a specific interest of the user for a content that is reproduced at this position. Additionally on the basis of such a course of movement, a user typical behavior can be derived. From this again a specific user, possibly in connection with the evaluation of additional identifications, can be identified or a profile that is assigned to the user can be selected.

In a preferred embodiment, from the behavior profile data is derived and stored in the profile. One can derive for example from the behavior whether a user preferably works late at night on a computer or which information type a user requests at a certain time of day. This can be taken into consideration for example upon the selection of additional information such that depending on the time of day the additional information on a home page is selected.

Preferably the profile server is assigned to a tracking system.

Today it is common that one or more additional information servers that are assigned to the information server are assigned to a so-called tracking system. Such a tracking system can be obtained, for example at http://www.zanox.de or at http://www.affilinet.de. A tracking system makes it possible for an information server to select on the one hand one or more of the tracking systems assigned to the additional information server. On the other hand, the information server can leave behind additional information there, which information is then reproduced on network pages of other information servers by potential additional information servers which are registered with the tracking system.

A tracking system thus manages for example web partners to an online shop. The online shop itself must not necessarily possess in this case information about the identity of the advertising partner itself. As a matter of usefulness, however, the tracking system will inform the online shop regularly of the then current advertising partners assigned to the online shop.

Where one or more of the additional information servers assigned to the information server is assigned a tracking system, then upon activation of a link by a user, the information server causes the client to transfer to the respective additional information server all the there stored cookies that were set by the additional information server that is assigned to the tracking system on the client. The additional information servers, in turn, which obtain from it a copy of the cookies set on the client, forward a message to the profile server, which establishes a profile therefore or updates a profile.

Naturally it can be conceived that both the tracking system and the profile server are realized in software that is in the form of computer programs. It is thus especially possible that the tracking system and the profile server run on the same computer system and are merely functionally separated.

According to a preferred advantageous development of the process for the selection of a to be reproduced additional information at least one of characteristics assigned to the additional information is evaluated. This makes it possible to not only select the additional information depending on the user profile but also depending on higher level parameters.

Preferably the characteristic describes a time, a time span, a branch, a thematic area, a number of activations, a number of leads, a number of sales, or a conversion.

A time describes for example a time of day or a time of year within which the additional information should not or should actually be selected. A branch describes a classification of additional information in relation to an area of business. Thus it is possible to choose additional information especially when the additional information is assigned a line of business or a theme which is consistent with the profile's information.

Should the additional information be reproduced in the form of a link on the network page, then the additional information can be assigned a number of activations which describe how often the additional information has already or upon earlier reproductions been activated on a network page. Should the additional information lead to an additional information server, for example an online shop, on which a user must register in order to see the information, then it can be determined by a means of the number of leads how often a registration took place without additional information being requested, especially without a product having to have been bought. A number of sales describe how often on the basis of a reproduction of the additional information on a network page, actually the sale or the ordering of a product, took place. A conversion describes the relationship of leads that took place during a predetermined time to the sales that took place during this time span. Thus it can be conceived that additional information which relates to an online shop's products no longer be reproduced when it comprises a particularly high number of leads but only a very small number of sales. It is highly likely that such additional information is not relevant so that a reproduction of this information on the network page would highly likely lead to a waste of resources.

According to a particularly preferred embodiment in which a software element is assigned to the client, the selected additional information is transferred to the software element via the communication network and by means of the software element the reproduction of the additional information is caused.

Such a software element can be for example the browser that is running on the client. It can thus be conceived that the browser integrates the additional information that is transmitted to it into the network page that is to be reproduced. It can additionally be conceived that the browser sets aside an area or several areas for the reproduction of the additional information and that the additional information is reproduced in this area. The software element can be designed as a so-called plug-in. A plug-in is a software component which is added to existing software and thus furthers the functionality of the existing software.

This embodiment has the advantage that the additional information is transmitted directly to the client without having to first be transmitted to the information server. Thus again resources can be spared. In particular the calculation ability of the information server is less burdened and the communication network is less burdened because the data representing the additional information need only be transmitted once.

Preferably the selected additional information is transmitted directly to the client from the profile server or the additional information server. Thus an additional reduction in burden on the communication network is achieved.

In additional advantageous development of the process the network page that is requested from the first information server or from the second information server is transmitted to the client in the form of an RSS feed.

RSS is a descriptive language and defines a data format enabling articles or their brief descriptions, for example news announcements, are stored on an information server and are can be provided in machine-readable form. A so-called RSS feed or newsfeed consists of an XML file which holds ready only the content that is for example the actual news piece of a news page but which contains no layout or design. Many pages which regularly publish articles, generate a so-called RSS file with the newest articles and publish these by means of an information server.

According to this additional development, it is on the one hand possible to generate, depending on a subscribed to RSS feed, profile data about the user in that for example the themes of the subscribed to RSS feed are taken into consideration in creating the profile. On the other hand it is possible to add additional information to an RSS feed that is transmitted from an information server to a client or to cause such additional information to be transmitted to the client.

According to an additional preferred embodiment of the process according to the present invention, independent of the request of a network page on the first information server, a transmission of additional information to the client is automatically caused. In this case the automatic request of the additional information can for example be executed by means of the software running on the client. Advantageously, the additional information that is thereupon transmitted to the client can then also be reproduced by the software element. This enables consequently the completely automated transmission of additional information to the client or to the user.

According to an especially preferred execution form of the process according to the present invention, the client requests from the first information server a home page. The information server thereupon transmits the selected additional information as part of the requested home page to the client. As an alternative to this the information server provides the home page with at least one pointer to at least one additional information that can be activated

A home page is also designated as a home page and describes the page which is transmitted according to standard from an information server to the client. The URL that is assigned to the home page resides here typically on the highest level and is for example identical with the URL that is itself assigned to the information server. Internally this URL points to a special File, which is for example designated as “index.html” or as “home.htm”.

Such a home page is often requested particularly in a first home page through input of a URL if the user wants to request some information that is provided by the information server. Many information servers make it possible even that access to callable information be exclusively via special input fields or links that are reproduced on the home page. It is consequently of a particular advantage if the additional information can already be transmitted together with the home page to the client requesting the home page or be requested by activating the link that is reproduced on the home page. Thus the number of requests for additional network pages can be reduced. In particular a forecast can implicitly be created through the evaluation of the profile assigned to the user as to which information the user will request in all likelihood. Should the home page be, for example, assigned to a search engine, then the result can be achieved that the user no longer even needs to input the search term if additional information is already pointed out on the home page according to which the user would actually want to search by inputting a search term.

Should the first information server be designed as an online shop, then it is possible with this execution form to point the user even on the home page of the online shop to one or more additional information relating to one or more products which would be highly likely purchased by the user.

By means of such a personalized home page consequently the sum is reduced of the data exchanged between the user assigned client and the information server, for example the online shop, via the communication network because a majority of network pages need not be requested by the user by means of the client of the information server in order to finally find a particular product.

Preferably in this case additional information are reproduced on a home page of the first information server which is provided by an additional information server which is assigned to the second information server or an additional information server.

Should for example the first information server be an online shop and should the user request the home page of this online shop by means of a client, then it can be provided that additional information is reproduced on the home page which describes a product that is offered for sale by another online shop. Should the user perform an action as to this additional information by means of the client, then it can be conceived that the user of the first online shop obtains a compensation.

It is thus possible to further reduce the burden on the network because the additional information can be reproduced to a client user already then when the user requests a home page from the first information server. When at this point the profile according to the present invention is evaluated, then a particularly high relevance of additional information can be obtained. This means that a user can be pointed to highly current and highly relevant additional information independent of the home page that he requests, whereby this additional information does not necessarily have to originate from the first information server but from each of the other communication network connected information servers that can be provided.

In particular, such additional information can naturally be provided by an independently operated additional information server.

Should the user thus request an additional network page from the online shop, then a characteristic that is assigned to this network page can be evaluated by means of the process according to the present invention. This characteristic can for example describe the content, or a part of the content, or it can at least classify a part of the content. Together with the result of the evaluation of the profile an even higher relevance of the to be transmitted additional information can be achieved, because a current user interest is combined with interest profiles that are generated from one or more earlier profile data.

According to an additional advantageous embodiment of the process, in which the first information server is designed as an online shop, the purchase of a product comprises of multiple actions. The action comprises for example an order, an order confirmation, a payment, or a shipment of goods. In this form of execution, the purchase of a product offered by the online shop is initiated. The additional information relates to an additional product and the purchase of the additional product is thus also initiated. In this case the additional information can be for example advertising banners which are assigned to a link that can be activated. An activation of the link can for example add the product automatically to the virtual sales basket or can automatically cause the ordering of the additional product. It is particularly advantageous in this case, if upon the purchase of the additional product, at least one action is executed together with the appropriate action that is to be executed for the purchase of the product offered by the online shop. As an example only one payment for both products is executed together or both products are shipped together.

The additional product does not need to be offered for sale in this case by the first information server. It can rather be conceived that an additional product is offered for sale by another online shop, with the first information server thus only transmitting to the user or the client a link to the second online shop and thus to the product offered by it. By means of this execution form the burden on the communication network can again be reduced.

The assignment is also solved through a Client-Server-System mentioned herein before, wherein
the Client-Server-System provides for at least a second information server;
the second information server is connected to the communication network;
the Client-Server-System provides for a profile server;
the profile server provides means for the design of a profile depending on the evaluation of at least one profile data;
the Client-Server-System provides for means to determine the profile data depending on at least one characteristic of one of the network pages which is to be transmitted by the second information server to the client.

Preferably the Client-Server-System provides for the execution of the process according to the present invention.

The invention is solved also through a profile server whereby the profile server provides for means for the execution of the process according to the present invention.

Of particular significance is the realization of this invention in the form of a computer program. In the process the computer program can be run on at least one calculating device or a computer and in particular on a server and is programmed to execute the process according to the present invention. Specifically for the execution of the process according to the present invention, portions of the computer program can run on different computers. The invention is thus realized through the computer program so that the computer program reproduces the invention in the same manner as the process to which the execution of the computer program is suited.

The computer program is preferably stored on a storage element. A storage element can specifically be a random access memory, a read-only memory, or a flash memory.

Additional characteristics, application possibilities, and advantages of the invention result from the following description of possibilities of invention execution which are reproduced in the drawing. In this case all described and reproduced characteristics form for themselves or in any desired combination the subject of the invention, independent of their summary in the patent claims or their reference as well as independent of their formulation or reproduction in the specification or in the drawing. In the drawing it is shown in:

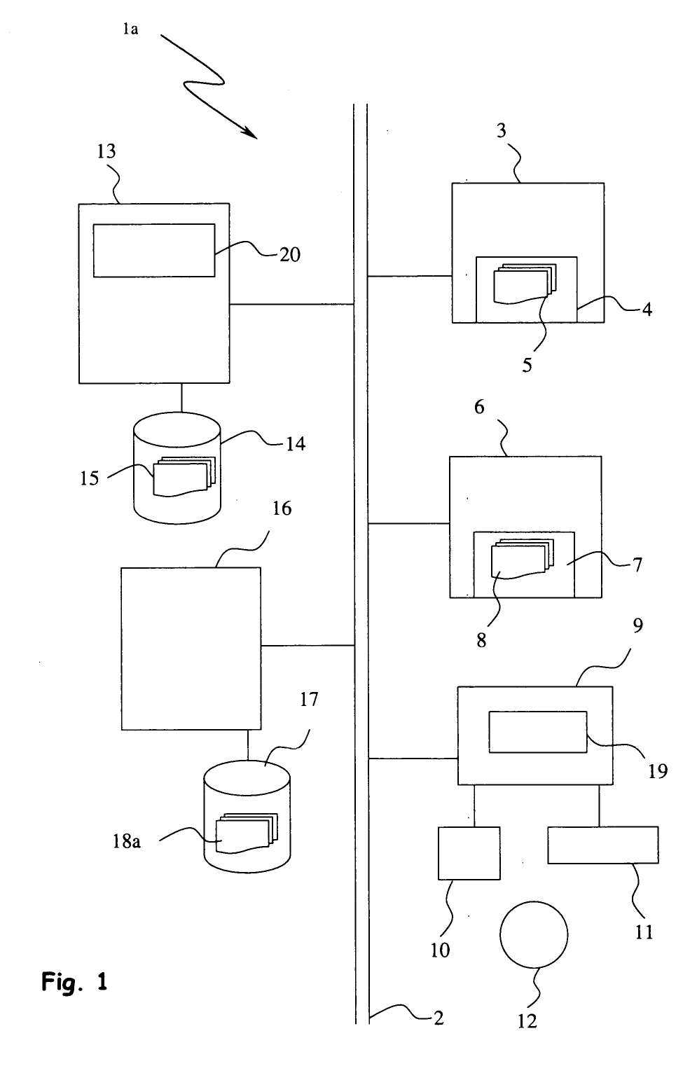

FIG. 1 a Client-Server-System according to the present invention in a first execution form;

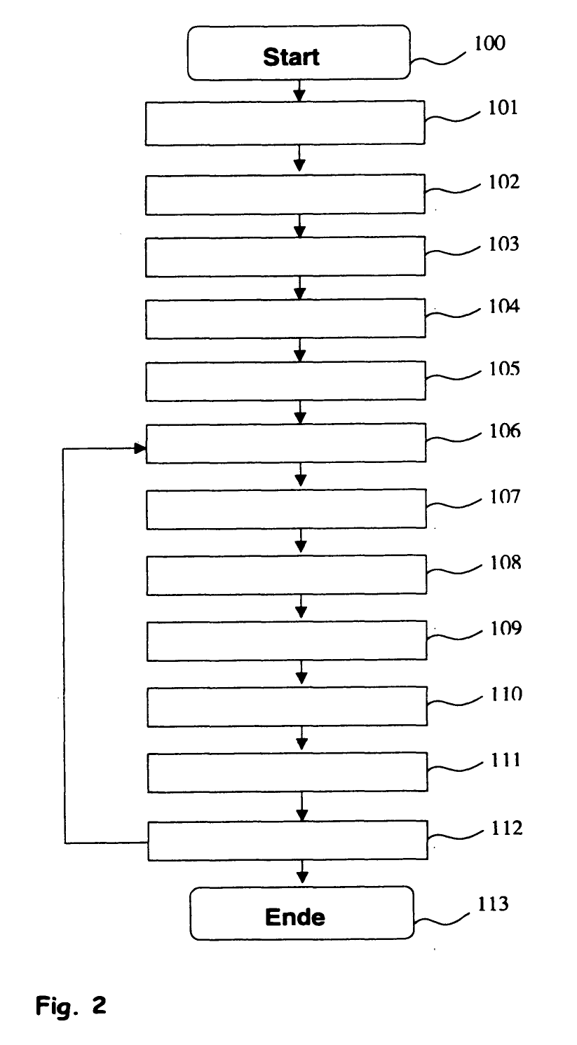

FIG. 2 a process diagram of a process according to the present invention in a first execution form;

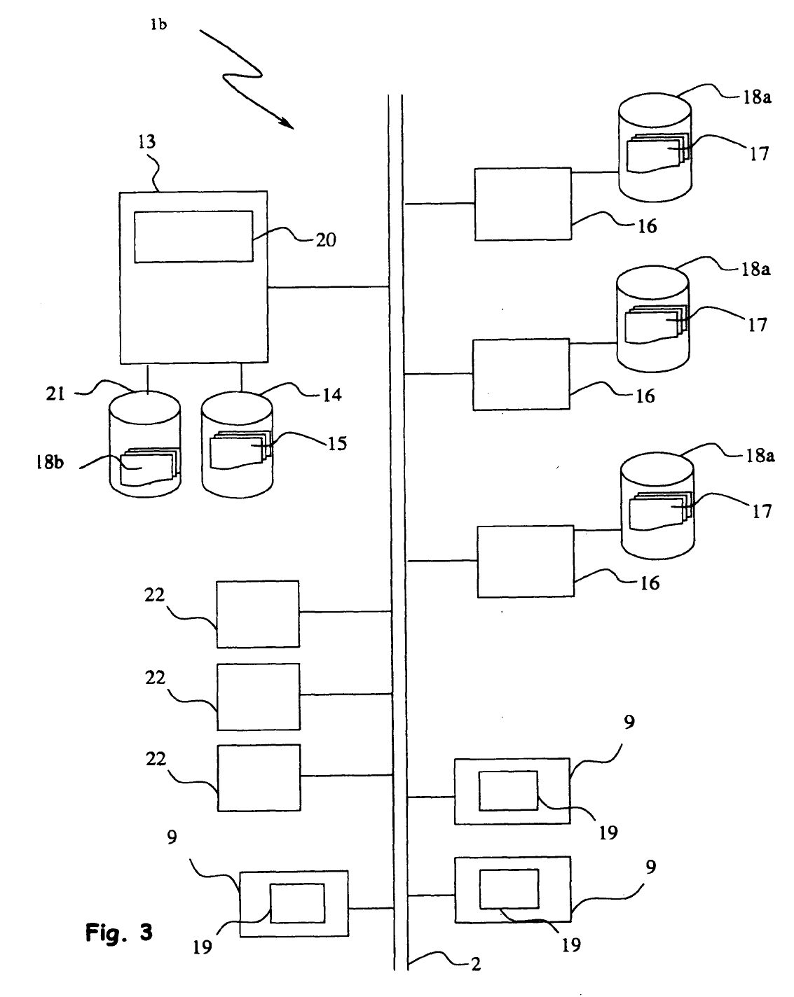

FIG. 3 a Client-Server-System according to the present invention in a second execution form;

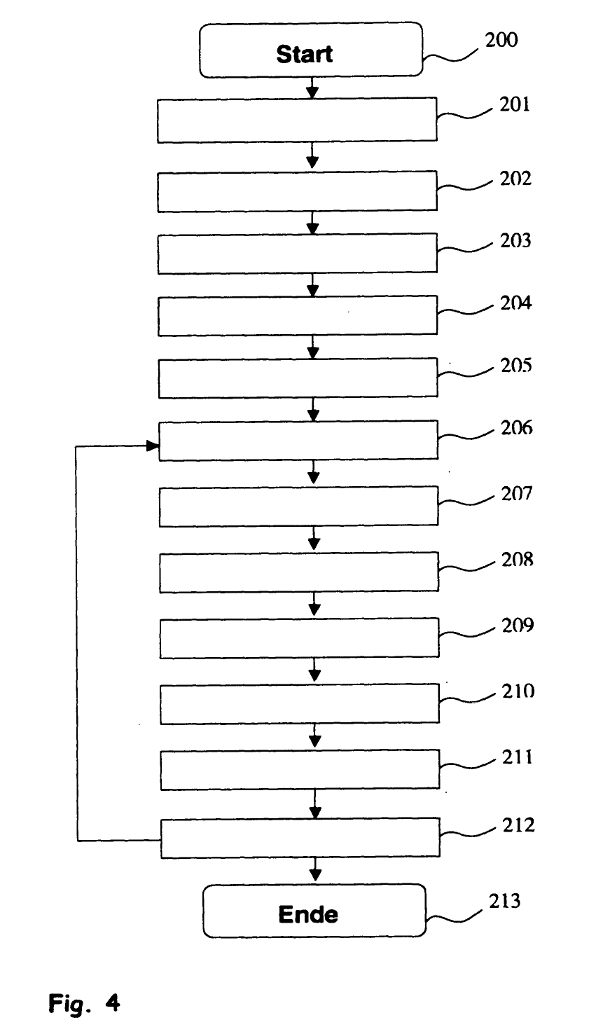

FIG. 4 a process flow diagram of a process according to the present invention in a second execution form.

In FIG. 1 a Client-Server-System according to the present invention is schematically reproduced, which is suitable for the realization of the process according to the present invention. The Client-Server-System 1a comprises a communication network 2 which is designed for example on the internet. The communication network 2 can be just as well designed on a radio network.

To the communication network 2 a first information server 3 is connected. The first information server 3 comprises a storage area 4 in which one or more network pages 5 are stored.

The Client-Server-System 1a additionally comprises a second information server 6 that is connected to the communication network 2. The second information server 6 also comprises a storage area 7 in which one or more network pages 8 are stored.

The Client-Server-System 1a also comprises a client 9. The client 9 has assigned to it a display 10 and an input device 11. The client 9 can for example be designed as a personal computer (PC). The client 9 can also be designed as a mobile telecommunication device or as a pocket computer (PDA, handheld). The input device 11 can for example be designed as a computer keyboard, a computer mouse, a touchpad or the numerical keyboard of a mobile telecommunication device. The display 10 and the input device 11 serve the interaction between the client 9 and a user 12. The input device 11 can thus be in particular a pointer device.

A profile server is additionally connected to the communication network 2. The profile server 13 is assigned to a database 14. In the database 14 at least one profile 15 is stored.

The Client-Server-System also comprises an additional information server 16 which is assigned to a database 17. In the database 17 additional information 18a is stored.

On each of the individual components of the Client-Server-System 1a, and especially on the profile server 13, the first information server 3, the second information server 6, the additional information server 16, as well as the client 9, computer programs run which enable the communication of the components with each other.

For example a browser 19 runs on the client 9, which makes it possible to evaluate user 12 input and to transform it into a request for a network page on the first information server 3. Additionally the browser 19 makes it possible that a network page 5, 8 received from the client 9 is interpreted and reproduced to the user 12 for viewing on the display 10. On the profile server 13 an expert system 20 also runs. The expert system 20 can for example be designed as a rule based expert system 20.

In FIG. 2 the Client-Server-System 1 is reproduced functionally in a first execution example. The process begins in a step 100. In step 101, the client 9 requests from the second information server 6 a network page 8. The request is started by the user 12 inputting by means of the input device 11a URL in an input window that is assigned to a browser 19. The browser 19 thereafter causes the client 9 to request from the second information server 6 the network page 8 which is addressed by the URL. The second information server 6 thereafter causes the network page 8 requested by the client 9 to be transmitted to the client 9 by means of a communication network 2.

In step 102 the profile data is transmitted by the second information server 6 to the profile server 13. In this case, the profile data can for example be a generic term that is assigned to the network page 8 transmitted by the client 9, which describes the content of the network page 8. In this case for example the network pages 8 that are stored on the second information server 6 are classified according to prescribed criteria. Such criteria can be generic terms which describe the content of the network page. If the second information server 6 is designed as a search engine, then the criteria can be a search term that is transmitted by the user 12 by means of the client 9 to the search engine. If the second information server 6 is a product search engine, then the criteria can be the designation of a searched or reproduced product itself or a generic term of the product. If the second information server 6 is an online shop, then the criteria can be a business branch or service within which the online shop offers goods or in which a product purchased by the user 12 is to be assigned. Additional criteria can be information about the user 12 himself. For example, such information can be determined by an online shop at the time of ordering a product and can include name, address, gender, and age.

If the second information server 6 is designed as an online forum, then the criteria can be the generic terms from articles that the user 12 has read or to which he has written something. Many online forums require a registration before the user 12 can actively participate. The files that are presented there can equally be used as profile data.

The criteria can also describe a type of information. Thus, for example, a network page can be classified depending on whether there is text information, picture information, or video information reproduced on the network page.

If the user 12 requests additional network pages 8 from the second information server 6, then profile data can also be transmitted from there to the profile server 13. It can be specifically conceived to put the behavior of the client 9 or of the user 12 into the profile data in such a manner that for example the time period between the requests of two network pages 8 is made into a protocol. One can then conclude from this time period, whether the user 12 looked at the network page 8 that was transmitted to the client more closely, whether the information reproduced there was in fact of fundamental relevance to the user 12, or whether the user 12 requested an additional network page 8 only after a very short time period from the second information server 6 and thus the first transmitted network page consequently was only of very little relevance for the user 12. In this case individual or multiple network pages 8 can be connected to each other through links so that the user 12 by activating a link reproduced on a network page 8 automatically requests an additional network page 8 from a second information server 6. Should the user 12 only remain very shortly on the network page 8 before he requests the next network page 8 from the second information server 6 and should the user 12 request the next network page 8 in that he activates a link reproduced on the initially requested network page 8, then, despite only the short time of resting, the initially requested network page 8 can be assigned a certain relevance for the user 12 because after all the reproduced link was of significance to the user 12.

In particular, an evaluation on the basis of the activation of the next requested network page 8 by the link can deliver criteria for creating an information profile.

In step 103 the profile server 13 can determine on the basis of the profile data transmitted by the second information server 6 a profile 15 which can be assigned to the client 9 or to the user 12. Here in particular, the determination of the profile 15 may comprise the bringing of an already existing profile 15 up-to-date. Depending on the prescribed rules of the expert system 20, the profile data that exist for the profile 15 are evaluated and connected to a profile 15. Here in particular processes from artificial intelligence can be applied. The profile 15 determined from the profile server 13 is stored in the database 14.

In step 104 the client 9 requests from the information server 3 a network page 5. This can for example occur as a result of the user 12 activating a link by means of the input device 11 which is reproduced on a network page 5 that is already reproduced to the user 12 or in that the user 12 inputs a URL by means of an input device 11. The requested network page can for example be the home page of an online shop.

At least the first information server 3 is designed in such a manner that the network page 5 requested by the client 9, which is for example the home page, is provided with at least one additional information 18a that is it creates a so-called personalized home page. For the selection of a suitable additional information 18a the first information server 3 requests initially from the profile server 13 the profile 15 that is assigned the user 12 or the client 9. This takes place in the step 105. The profile server 13 thereupon transmits the requested profile 15 to the first information server 3.

In selecting the profile 15 assigned to the user 12, a identification assigned to the user 12 can be drawn upon. An identification of this type can be determined for example by the user 12 registering himself through the input of a user id on the first information server 3. Additionally an identification that is assigned the client 9 can be evaluated. In this case the information that is contained in a cookie that is stored on the client 9 can be evaluated. In addition the device number assigned to the client 9 can for example be evaluated.

If the client 9 is used by different users 12, the unambiguous identification of a user 12 can often not take place, especially if he does not register on the first information server 3 by means of a user id. Here it can be particularly of advantage to draw upon additional information or the identifications for the identification of the user 12 and thus for the selection of the profile 15. Such information can for example be recognized through the evaluation of the behavior of the user 12. For example the position of a pointer device, that is, for example of the input device 11, is recognized. In this case for example the X-Y coordinates of the pointer device in relation to the display 10 can be recognized.

In particular the course of movement of the pointer device can be captured. In this case for example a sequence of the X-Y coordinates can be captured. Preferably the X-Y coordinates are captured according to a time so that for example also a period of resting can be captured. By means of this information behavior that is typical for the user 12 can be recognized and thus extrapolated to the identity of the user 12 such that the profile 15 assigned to the user 12 is selected.

The assimilation of the behavior of the user 12 can again be used in order to bring the profile 15 assigned to the user 12 up-to-date.

The profile 15 can itself only describe a specific class of users 12 which conform to one or more characteristics or profile data. This means that the profile 15 does not exclusively have to be assigned to a specific user 12. By capturing the behavior of the user 12, the profile 15 can consequently be very easily selected if this profile 15 describes or is assigned just such behavior or a particular class of behavior types.

In step 106 the first information server 3 evaluates the profile 15 obtained from the profile server 13. In this case for example a declaration can be contained in the profile 15 as to which themes the user 12 in recent times was particularly interested in. It can also be conceived that the profile 15 contains information as to which products the user has looked at on an online shop in the past, noted for future purchase, purchased, or actually not purchased.

In step 107 the first information server 3 requests via the communication network 2 depending on the evaluation of the profile 15 performed in the step 106 from the additional information server 16 additional information 18a that is consistent with the profile 15. In this case it is assumed that the additional information 18a stored in the database 17 is filed according to particular criteria that are known by the first information server 3. The additional information server 16 selects depending on the request of the first information server 3 the appropriate additional information and transmits this in a step 108 to the first information server 3.

In step 109, the first information server 3 causes the additional information 18a that is transmitted by the additional information server 16 to be assimilated on the requested network page of the client 9. This can happen for example in that an area on the network page 5 is provided for the acceptance of one or more bits of additional information 18a. The additional information 18a can be for example a link to a different network page which can be called by the first information server 3, by the second information server 6 or another information server. In this case it can be provided that the link be supplemented by a textual or graphic information. The additional information 18a is for example a so-called advertising banner which advertises by means of a textual and/or graphic reproduction for a product that is to be obtained on an online shop or for a service that is provided through an online shop.

In step 110 the network page 5 is transmitted via the communication network 2 to the client 9. It can for example be the client 9 requested home page of the first information server 3 which is enriched by the additional information 18a.

In step 111 the behavior of the client 9 or of the user 12 is evaluated following the transmission of the network page 5. In this case, how the user 12 specifically reacts to the additional information can be taken into consideration. In this case the additional information 18a is for example provided with a link that can be activated by the user 12. Such an activation can be made into a protocol by the first information server 3. A profile of information can be generated from this and this information can also be drawn to the profile server 13 in step 112 in order to bring the profile 15 of the client 9 or of the user 12 up-to-date. Specifically the behavior of the user 9 can also again be derived as a result of a position or by a series of movements of the pointer device that is assigned the client 9.

According to another embodiment, the additional information 18a is, diverting from the steps 109 and 110, not integrated into the network page 5, 8 requested by the client 9 from the first information server 3 but the additional information 18a is transmitted separate from the requested network page 5, 8 to the client 9. To this end, the client 9 provides for suitable means for the reproduction of the additional information 18a. This can for example be realized through the implemented running of a software on the client 9 which enables the reproduction of the additional information. A reproduction can in this case take place together with a network page 5, 8 that is transmitted from the information server 3 by means of the browser 19. In this case the software can for example be integrated in the form of a so-called plug in into the browser 19. A reproduction can also result especially in a separate area of the browser 19. In this case it can be conceived that the reproduction is made independent of the time of the reproduction of the requested network page 5, 8.

It can consequently be imagined that the additional information 18a is reproduced on the client 9 at a certain time before or after the reproduction of the network page 5, 8. For example a time delay of the reproduction of the additional information 18a can result in that the additional information 18a must initially be determined as is reproduced in FIG. 2. A time delay in producing the additional information 18a can of course also be consciously prescribed.

In particular it can be conceived so that the additional information 18a is not transmitted from the first information server 3 to the client 9 but is transmitted directly from the profile server 13 or the additional information server 16 to the client 9 and is reproduced to the user 12 by the client 9 together with the network page 5, 8 or independent thereof.

Should a second information server 6 be realized as a search engine, then the input of the search term can determine profile data through the user 12 by means of the client 9 and the transmission of the search term to the second information server 6, which information is used by the profile server 13 for creating or updating the profile 15. Should the user 12 request at a later point in time a network page 5 from the information server 3, then the additional information 18a can be selected by taking into consideration the prior used search term. For example the user 12 can be shown an advertising banner by means of client 9 which banner is thematically related to the prior input search term. The advertising banner can then be reproduced in a separate area of the browser 19 or be integrated in the requested network page 5.

The process reproduced in FIG. 2 can naturally also be executed in irregular repetitions of individual parts. For example the process according to step 112 can be continued in the step 103. In particular the process can be executed multiple times in delayed time or in parallel as is common for processes realized in a Client-Server-System 1a. In this case several users 12 can send one or more inquiries to one or more first information servers 3 or to a second information server 6.

In FIG. 3 an additional embodiment of a Client-Server-System 1b according to the present invention is reproduced.

The Client-Server-System 1b that is reproduced in FIG. 3 comprises a communication network 2 and a profile server 13. The client 9 is designed according to the client 9 reproduced in FIG. 1. The profile server 13 is assigned to a database 15, in which at least one profile 15 is stored. The profile server 13 is additionally assigned a database 21 in which additional information 18a is stored.

The Client-Server-System 1b comprises several additional information servers 16 which are each assigned a database 17 in which the additional information 18a is stored. The additional information servers 16 are connected to the communication network 2.

The Client-Server-System 1b comprises several information servers 22. The information servers 22 can comprise the functionality of the first information server 3 reproduced in FIG. 1 or of the second information server reproduced in FIG. 6. In particular at least one information server 22 can comprise both functionalities. This means that an information server 22 can transmit both profile data to the profile server 13 as well as reproduce additional information 18a on a network page 5, 8 that is requested by the client 9. Each of the information servers 22 can be designed independent of the others as for example as an online shop, a search engine, a product search engine, a newspaper, or an online forum.

In FIG. 4, the process according to the present invention is reproduced in detail in an additional embodiment as derived from the Client-Server-System 1b reproduced in FIG. 3.

The process reproduced in FIG. 4 starts in a step 200. In a step 201, the client 9 requests a network page 5 from an information server 22.

In step 202 the information server 22 causes the profile server 13 to generate a identification and to set a cookie on the client 9. This can occur for example by the network page 5, 8 being activated through a link that is reproduced on a previously requested network page, whereby a pointer is assigned to the link to the profile server 13 in the form of a URL and this URL points to a script so that the activation of the link causes an execution of the script that is stored on the profile server 13. The running of this script can again have as a consequence the generation of a cookie and can transmit this to the client 9.

In step 203 the information server 22 transmits profile data to the profile server 13. This can take place depending on for example the network page 5, 8 that was earlier requested by the client 9 from the information server 22. The profile data can for example be a product purchased on the information server 22, an input search term, a theme of an online forum, a branch of an online shop, the age and gender of the user 12, a product that was not purchased, or a requested information.

In step 204 the profile server 13 creates a new profile 15. If a profile 15 already exists for the user 12, the profile server 13 updates the existing profile 15. In the process, it can for example be provided that all or only specific profile data, the compilation of which takes longer than a prescribed time span, is erased and no longer taken into consideration when creating or updating the profile 15. This heightens for example the adaptability of the profile creation and permits a flexible reaction to the changed habits, needs, or interests of the user 12. The created profile 15 is then stored in the database 14. The database 14 can for example be designed as a storage area in a working memory.

In step 205 the client 9 requests an additional network page 5, 8 from one of the information servers 22. In the process the information server 22 need not distinguish itself from the information server 22 from which the client 9 previously requested a network page 5, 8. This network page is for example a home page assigned to the information server 22.

In step 206 a identification is created by the profile server 13 analogous to the step 202 or the identification assigned to the client 9 is determined by means of a request of the cookie that is stored on the client 9. The identification can naturally also be determined analogous to the process reproduced in FIG. 2 through the evaluation of a behavior of the user 12 or through the evaluation of a pointer device's flow of movement.

In step 207 the profile data is transmitted analogous to step 203 from the information server 22, from which the client 9 had just requested a network page 5, 8 in the step 205, to the profile server 13.

In step 208 a profile is updated or created analogous to the step 204.

In step 209 the profile server 13 chooses additional information which is to be reproduced on the network page 5, 8 requested by the client 9 in the step 205. To this end, the profile server 13 evaluates the profile 15 assigned to the client 9 that is stored thereon by means of a identification that is determined in the step 206. To this end keywords can be extracted from the profile 15 according to which then one can search for appropriate additional information 18a on the additional information servers 16. In the profile server 13 a database 21 can be assigned in which additional information 18a are stored. The database 21 enables the profile server 13 to search in the database 21 for additional information 18a which sufficiently reflect the profile 15 that is present. To determine whether additional information 18a reflects a profile 15 or how well it reflects it, known processes from the information retrieval (information retrieval) sector and from the automatic classification (automatic classification, document clustering, keyword clustering) can be called upon enabling for example so-called matching functions can be developed and employed.

The profile server 13 can for example be designed as a tracking system. The additional information 18a stored in this database 21 can in this case be advertising information that are reproduced on the network pages 5, 8 that are transmitted from an information server 22 to the client 9.

In step 210 the selected additional information 18a is transmitted to the information server 22. This reproduces the selected additional information 18a on the to be created network page 5, 8, for example the home page. In the process, the additional information can be specifically designed as a link to an additional network page which is provided by the same or another information server 22. If the network page 5, 8 is a home page, then the creation of a personalized home page can be thus realized. This means that the information that is reproduced in the home page is selected depending on the user 12 who requests the home page. In this case almost all information reproduced on the home page can be designed as additional information. For example only a mere pointer to the company which is assigned to the home page is contained as a standard on each home page. All additional information can be realized in the form of additional information 18a selected according to the present invention, so that such a home page can be specifically fit to the requesting user 12.

In step 211, the network page 5, 8 that is provided with the additional information 18a and is requested from the client 9 in the step 205, that is for example the personalized home page, is transmitted to the client 9 via the communication network 2.

In step 212 the user 12 activates a link that is reproduced on a network page 5, 8 and which is transmitted in the step 211. This can for example be a link that is reproduced by means of additional information 18a. The link is organized in such a way that the information is transmitted to the profile server 13 which indicates the activation of this link. This can be evaluated by the profile server 13 as a bit of profile data and can be accordingly set on the profile 15.

If the additional information 18a is an advertising banner and if the thus reproduced link leads to a product of an online shop, then the purchase of this product can also be evaluated as profile data. In this case, a note can for example be made on a profile to continue to point links to the online shop, for example in order to point to available accessories for the purchased product. However, at the same time, it can also be determined not to point additional advertising banners for this online shop on one of the network pages 5, 8 requested by the client, since for example, it could be highly unlikely that the user 12 would intend, because of a particularly small assortment of goods at the online shop, to use the online shop again in the foreseeable future for a purchase.

The process can end in a step 213. Preferably, however, the process will be continued in to step 206 in that additional behavior of the user 12 is evaluated for creating and updating the profile 15 assigned to the user 12. Thus a particularly current profile 15 can be obtained.

A first concrete flow of the process according to the present invention can appear for example as follows:

The user builds by means of a client 9, which is designed as a notebook, a connection to the communication network 2, which is designed as the internet, and purchases a product via the second information server 6 that is designed as an online shop. During the purchase profile data is created that contains information about the product itself—for example the description of the product itself and its price-, and about the user 12 himself—for example his age and gender-, and about the purchase itself—payment by credit card or according to last name as well as the purchase date.

This profile data is transmitted to the profile server 13, is processed in an appropriate manner, and then stored in the database 14 in the form of a profile 15.

Should the user 12 a few hours or days later now request a network page 5 from the first information server 3 that is designed as a search engine, then the first information server 3 will request from the profile server 13 the user 12 assigned profile 15. For the selection of the profile 15, the profile server 13 requires an identification of the user 12. This can for example take place by means the personal data of the user 12 which are transmitted at the time of purchase.

An identification of the user 12 can take place by the transmission of a client 9 assigned, unambiguous device number, for example the number of a so-called network card that is present in the client 9 and automatically upon the request of network pages 5, 9 be sent to the information servers 3, 6, and transmitted by the information servers 3, 6 to the profile server 13, and from this then stored together with the profile 15 in the database 14.

An identification of the user 12 can also take place, especially since the client 9 is caused by the information servers 3, 6 to set a cookie upon the request for a network pages 5, 9. The required information for setting the cookie can be transmitted from the information servers 3, 6 to the client 9. A cookie is usually realized in such a manner that it can only be sent back to the information servers 3, 6 which causes the client 9 to set the cookie. Should the client 9 request a new a network page 5, 8 from the information servers 3, 6, then the cookie can be transmitted together with the client 9 request to the information servers 3, 6.

In this case, it is especially advantageous when the setting of the cookie is caused by the profile server 13. This can be achieved for example by the information servers 3, 6 requesting a network page 5, 8 from the client 9 and transmitting the data to the profile server 13 which data are necessary for the transmission of information to the client 9. This is for example can be the network address of the client 9. This address is transmitted from the information server 3, 6 to the network pages 3, 6 depending on the transfer protocol used by the client 9 upon the request of a network page 5, 8. This makes it possible for the information server 3, 6 to transmit to the client 9 the network page 5, 8 requested by the client 9.

If the profile server 13 recognizes this address, then it can send information to the client 9 and cause it as a result to set a cookie. This cookie can for example be a identification that is created by the profile server 13. Should the user 12 request a network page 5, 8 by means of a client 9 from the same or of another information servers 3, 6 then the profile server 13 is caused to request the cookie stored there from the client 9. By selecting the cookie, the profile server 13 then obtains the identification assigned to the client 9 or the user 12 and can choose on the basis thereof from the database 14 the profile assigned to it.

Should the client request for example a network page 5, 8 from the information server 3, 6 through activation of a link that is reproduced on another network page, then it can be provided that the activation of the link automatically results in the sending of an information to the profile server 13 and a script is thereby executed on the profile server 13 which then causes the profile server 13 to send a message to the client 9 so that the client 9 stores the information contained in this message, in a storage area assigned to the client 9 in the form of a cookie, for example the information being the identification that is created by the profile server 13

Should the information servers 3, 6 request a profile 15 from the profile server 13, then the profile server 13 will request in the meantime the cookie that is set on the client 9 and then choose from the database 14 the profile 15 that is assigned to it on the basis of the identification that is stored in the cookie.

In the profile 15 it can thus be noted which product the user 12 previously purchased. As additional information 18a, a link can for example be integrated to an accessory in the newly requested network page 5, 8.

If the user 12 has purchased for example a vacuum cleaner, then additional information 18a can be integrated in the form of a link to the offeror of replacement bags in a network page 5, 8 that is requested after the purchase.

Should the user 12 search in a search engine for the terms “home improvement”, then information about sellers of construction material or tips on home construction can be transmitted as additional information 18a.

According to an additional embodiment, the profile 15 is not stored in a database 15 that is assigned to the profile server 13, but rather directly on the cookie that is stored on the user 12 assigned client 9. If the information server 22 transmits new profile data to the profile server 13, then the profile server 13 updates the client 9 assigned profile 15 and causes the profile 15 to be updated by setting a new, current cookie on the client 9.

In particular the profile 15 can designate a specific user type, so that consequently more users 12 can be assigned to the profile 15 and thereby a user 12 classification can be achieved.

Additionally, the process according to the present invention can naturally comprise of a multitude of requests for network pages 5, 8 and from one or more information servers 3, 6, 22 which take place as soon as a profile 15 exists. In these cases, the process according to the present invention can for example be started in the step 103.

The embodiments reproduced in FIGS. 2 and 4 are naturally only examples of embodiments. Thus it is especially possible to summarize several steps, exchange or even cancel individual steps, and to change the functionality of individual steps so long as the inventive thoughts that are the source of the invention are realized.

For example it can be conceived that the transmission of additional information that takes place in steps 108 and 210 does not take place on the first information server 3 or on one of the information servers 22 but is transmitted directly to the client 9. This can happen for example by the profile server 13 choosing the additional information 18a from the database 21 assigned to it and transmitting this to the client 9 where it is integrated through the browser 19 by means of a plug-in into the to be reproduced network page 5, 8 or is reproduced in an area that is provided exclusively therefore. It is also possible that the profile server 13 causes the additional information server 16 to transmit the additional information 18a directly to the information server 3, 22 or directly to the client 9.

In particular, a software element, or a software, can run on the client 9 and automatically request additional information 18a from the additional information server 16 or from the first information server 3. Such a software can for example be the browser 19. However this can also be any another type of software. In this case it can be conceived that a software is provided for use by the user 12 in an especially favorable manner or free of charge but that the software when it is installed on the client 9 automatically requests at predetermined points in time additional information 18a from the first information server 3 or the additional server 16 and shows this to the user 12 on the display 10. If this additional information 18a is an advertisement, then with that the software can be financed.

At the same time, as a result of the evaluation of the highly updated profile 15 at the selection of the additional information 18a, the process according to the present invention guarantees that the selection of additional information 18a is of a high relevance to the user 12. In particular the behavior of the user 12 can in this case be evaluated such that it follows that a potential future need for information by the user 12 can be automatically recognized and thereupon an appropriate additional information 18a be automatically requested and transmitted to the client 9 or the user 12.

1. Process for the transmission of information from a first information server (3) to a client (9), wherein
the first information server (3) and the client (9) are connected to a communication network (2),
a profile (15) is assigned to the client (9)
at least one additional information server (16) is connected to the communication network (2),
at least one additional information (18a) is provided by the additional information server (16) for request,
by means of the client (9) a network page (5) is requested from the first information server (3) via the communication network (2),
depending on the profile (15) assigned to the client (9) additional information (18a) is selected; and
the requested network page (5) and the additional information (18a) is transmitted to the client (9);
characterized in that at least a second information server (6) is connected to the communication network (2), the profile (15) is created by a profile server (13) that is connected to the communication network (2), and for the creation of the profile (15) at least one profile data is evaluated, whereby the profile data is determined depending on at least one characteristic of a network page (8) transmitted to the client (9) by the second information server (6).

2. Process according to claim 1, characterized in that the first information server (3) and/or the second information server (6) is designed as a search engine, a product search engine, an online shop, an online forum, or a news server.

3. Process according to claim 1, characterized in that a condition is assigned to the profile data and the profile data is taken into consideration for the creating the profile (15) only if the profile data meets the condition.

4. Process according to claim 1, characterized in that at least one characteristic is assigned to the network page (5) which is requested by the client (9) from the first information server (3) and the additional information (18a) is selected depending on an evaluation of this characteristic.

5. Process according to claim 1, characterized in that the at least one characteristic of the network page (8) transmitted from the second information server (6) to the client (9) or the network page (5) requested by the client (9) from the first information server (3) describes a content, a theme, a source, a time period, a realized action, or a non-realized action.

6. Process according to claim 1, characterized in that
the first information server (3) requests the profile (15) from the profile server (13),
the profile server (13) transmits the profile (15) to the first information server (3) and the first information server (3) selects the additional information (18a);
the first information server (3) requests the additional information (18a) from the profile server (13), whereby the profile server (13) selects the additional information (18a); or
the profile server (13) transmits the profile (15) to the additional information server (16) and the additional information server (16) performs the selection of the additional information (18a) depending on the profile (15).

7. Process according to claim 1, characterized in that for the assignment of profile data to a profile (15) at least one identification that is assigned to the client (19) and/or the user (12) is evaluated or that the profile (15) to be used for the selection of the additional information (18a) is selected by evaluating of at least one identification that is assigned to the client (9) and/or the user (12).

8. Process according to claim 7, characterized in that the identification comprises at least one of a cookie, a device number, a software number, or a dial-in number.

9. Process according to claim 7, characterized in that the behavior of the user (12) is evaluated and the identification is created depending on the evaluation of the behavior.

10. Process according to claim 9, characterized in that the behavior is determined depending on at least a position of a pointing device assigned to the client (9).

11. Process according to claim 9, characterized in that the behavior is determined depending on a movement of a pointing device assigned to the client (9).

12. Process according to claim 9, characterized in that profile data is derived from the behavior and stored in the profile (15).

13. Process according to claim 1, characterized in that for selecting the additional information (18a), at least one characteristic assigned to additional information (18a) is evaluated, wherein the characteristic describes at least one of a time, a time period, a business branch or service, a theme, a number of activations, a number of leads, a number of sales, or a conversion.

14. Process according to claim 1, characterized in that the client (9) comprises a software element, the selected additional information (18a) is transmitted to the software element via the communication network (2), and the software element causes the additional information (18a) to be displayed.

15. Process according to claim 1, characterized in that the network page (8) requested from the first information server (3) or from the second information server (6) is transmitted to the client (9) as an RSS feed.

16. Process according to claim 1, characterized in that a transmission of additional information (18a) from the first information server (3) to the client (9) is caused automatically and independently of the request of the network page (5).

17. Process according to claim 1, characterized in that the client (9) requests from the first information server (3) a home page and the first information server (3) transmits the selected additional information (18a) to the client (9) as part of the home page.

18. Process according to claim 1, characterized in that the client (9) requests a home page from the first information server (3) and the first information server (3) adds to the home page a link assigned to at least one of the selected additional information (18a) and the home page is transmitted to the client (9).

19. Process according to claim 1, characterized in that the first information server (3) is designed as an online shop that offers products for sale, a purchase of a product comprises several actions, a purchase of the product is initiated, the additional information (18a) relates to an additional product, the purchase of the additional product is initiated, and for the purchase of the additional product at least one action is performed together with the corresponding action that is to be executed for the purchase of the product that is offered for sale by the online shop, wherein the action particularly is an order, an order confirmation, a payment, or a shipment.

20. Client-Server-System (1a; 1b) comprising of a client (9) assigned to a user (12), a first information server (3), an additional information server (16), and a communication network (2), enabling a communication between the client (9) and the first information server (3), wherein
the Client-Server-System (1a; 1b) comprises means for assigning a profile (15) to the client (9),
the additional information server (16) is connected to the communication network (2),
the additional information server (16) provides at least one additional information (18a) for request,
the client (9) comprises means for requesting a network page (5) from the first information server (3) via the communication network (2),
the Client-Server-System (1a; 1b) comprises means for selecting additional information (18a) depending on the profile (15) assigned to the client (9); and
the Client-Server-System comprises means for transmitting the requested network page (5) with the additional information (18a) from the first information server (3) to the client (9),
characterized in that the Client-Server-System (1a; 1b) comprises at least a second information sever (6) that is connected to the communication network (2), a profile server (13) for being connected to the communication network (2), means for determining at least one profile data depending on at least one characteristic of a network page (8) transmitted to the client (9) by the second information server (6), means for evaluating the at least one profile data and means for creating the profile (15) based on the evaluation of the profile data.

21. Profile server (13) in a Client-Server-System (1a; 1b), wherein:
the Client-Server-System (1a; 1b) comprises a client (9) assigned to a user (12), a first information server (3), an additional information server (16), and a communication network (2)
the profile server (13) comprises means for assigning of a profile (15) to a client (9),
the additional information server (16) is connected to the communication network (2),
the additional information server (16) provides at least one additional information (18a) for request,
the client (9) comprises means for requesting a network page (5) from the first information server (3) via the communication network (2),
the Client-Server-System (1a; 1b) comprises means for selecting additional information (18a) depending on the profile (15) assigned to the client (9); and
the Client-Server-System (1a; 1b) comprises means for transmitting the requested network page (5) with the additional information (18a) from the first information server (3) to the client (9),
characterized in that the profile server (13) is connected to the communication network (2) and comprises means to for determining at least one profile data depending on at least one characteristic of a network Page (8) transmitted to the client (9) by the second information server (6), means for evaluating the at least one profile data, and means for creating the profile (15) based on the evaluation of the profile data.

22. Computer program which can be run on a Client-Server-System (1a; 1b), the Client-Server-System (1a; 1b) comprising a client (9) assigned to a user (12), a first information server (3), an additional information server (16), and a communication network (2) enabling a communication between the client (9) and the first information server (3), wherein
the Client-Server-System (1a; 1b) comprises means for assigning a profile (15) to the client (9),
the additional information server (16) is connected to the communication network (2),
the additional information server (16) provides at least one additional information (18a) for request,
the client (9) comprises means for requesting a network page (5) from the first information server (3) via the communication network (2),
the Client-Server-System (1a; 1b) comprises means for selecting additional information (18a) depending on the profile (15) assigned to the client (9); and
the Client-Server-System comprises means for transmitting the requested network page (5) with the additional information (18a) from the first information server (3) to the client (9),
characterized in that the computer program is further programmed for determining at least one profile data depending on at least one characteristic of a network page (8) transmitted to the client (9) by a second information server (6), evaluating the profile data, and creating the profile (15) based on the evaluation of the profile data.

23. Computer program according to claim 22, characterized in that the computer program is stored on a storage element, whereby the storage element is designed as a diskette, a compact disk (CD), a digital versatile disk (DVD), and/or at least a storage area assigned to at least one component of the Client-Server-System (1a; 1b).
